(19) United States
(12) Patent Application Publication
(10) Pub. No.: US 2008/0215998 A1
(43) Pub. Date: Sep. 4, 2008

(54) WIDGET LAUNCHER AND BRIEFCASE

(76) Inventors: Dennis B. Moore, Hillsborough, CA (US); Joerg Beringer, Los Altos, CA (US); Denis J. Browne, San Mateo, CA (US); Eric R.B. Wood, Menlo Park, CA (US); Frederic E. Samson, Wayne, PA (US)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/867,648

(22) Filed: Oct. 4, 2007

Related U.S. Application Data
(60) Provisional application No. 60/873,869, filed on Dec. 7, 2006.

(51) Int. Cl. G06F 3/00

(52) U.S. Cl. 715/762

(57) ABSTRACT

A system and method for persistently associating a control widget with a plurality of managed widgets operating within a widget runtime environment; changing a state of the managed widgets as a group, the state including one of open, closed, or hidden; and representing the changed state of the managed widgets via a display. Managed widgets having a closed state are neither displayed nor connected with a data source, widgets having an open state are both displayed and connected with a data source, and widgets having an intermediate state are not displayed (e.g. hidden) but are connected with a data source and capable of receiving updated information while hidden.

### RELATED APPLICATION

This U.S. patent application claims the benefit of priority of U.S. Provisional Application 60/873,869 filed Dec. 7, 2006.

### TECHNICAL FIELD

Embodiments of the invention relate to the field of end-user applications, and more particularly, to a system and method for persistently associating a control widget with a plurality of managed widgets operating within a widget runtime environment.

### BACKGROUND

Historically, “widgets” have been used to provide simple user applications having a narrowly defined scope of functionality and a dedicated purpose. Generally, historical widgets are visually contained within their own dedicated window and are capable of being repositioned on a computer's graphical user interface (“GUI”) desktop environment. Several well known historical widgets include “googly eyes,” which came standard with X11 windowing environments on many UNIX platforms and whose function was to peer in the direction of the cursor; analog and digital clocks that were commonly placed on a desktop merely for displaying the time; and cursor absolute position displays that converted the absolute position of a cursor to its numerical (x,y) coordinates equivalent for reference by the user.

In recent years, game widgets have been developed allowing users to play simple games inside a small desktop widget, examples of which include tic-tac-toe, hangman, and sudoku. Other widgets have been developed in recent times allowing a user to pull data from Internet sources not protected by firewalls or Enterprise level security protection. Examples include weather widgets that are dedicated to retrieving a brief weather forecast for a specific zip-code and mortgage rate widgets that display daily mortgage rate averages.

Prior art widgets must be selected and downloaded by end users as individual units and once downloaded, launched, used, and maintained individually. The prior art widgets typically operate in a widget runtime environment and have one of two states, opened and closed. Moreover, owing to the diversity of prior art widgets, it can be difficult for an end user find, download, maintain and organize a particular combination of widgets that perform all the various tasks the user desires. This problem is especially prevalent for Enterprise employees with job functions that consist of many distinct tasks and responsibilities. Using prior art widgets, an Enterprise employee with multiple responsibilities must download, launch, maintain, and track numerous widgets to perform the various tasks associated with his or her particular job function, which becomes costly in terms of use of the employee's time and effort.

### BRIEF DESCRIPTION OF THE DRAWINGS

The claims set forth the embodiments of the invention with particularity. Certain embodiments of the invention, together with its advantages, may be understood from the following detailed description taken in conjunction with the accompanying drawings. Embodiments of the invention are illustrated by way of example and not by way of limitation in the Figures of the accompanying drawings. It should be noted that references to “an,” “one,” “another,” “alternative,” or a “particular” embodiment in this disclosure are not necessarily referring to the same embodiment, although they may be, and such references mean at least one embodiment. Reference numerals are utilized herein to identify corresponding components of the Figures described below. Components corresponding to like reference numerals in multiple Figures represent like elements.

FIG. 1 illustrates a system for persistently associating a control widget with a plurality of managed widgets within a widget container according to one embodiment.

FIG. 2 illustrates the interactions and interrelationships of control widgets, managed widgets, and unmanaged widgets within a widget container according to a particular embodiment.

FIG. 3 illustrates a flowchart depicting various functional blocks, some optional, of a method for persistently associating managed widgets with a control widget in accordance with an embodiment.

FIG. 4 illustrates a flowchart depicting various functional blocks, some optional, of a method for changing the state of managed widgets persistently associated with a control widget from open to hidden in accordance with another embodiment.

FIG. 5 illustrates a flowchart depicting various functional blocks, some optional, of a method for changing the state of managed widgets persistently associated with a control widget from open to closed in accordance with one embodiment.

### DETAILED DESCRIPTION

A control widget as described herein can associate multiple managed widgets (e.g. desktop widgets, Enterprise widgets, business widgets, or Portable Logic Modules) into predefined or customized groups allowing Enterprise employees and other users better access to the tools or groups of tools that may be required to perform a particular task or job function.

A simple scenario illustrating the use of control widgets is that of an Enterprise employee whose job function is that of a sales person. Although the Enterprise employee has just one primary job function, a sales person, the Enterprise employee may operate within various contexts throughout any given period of time. For example, in one embodiment, the Enterprise employee is traveling on business and needs perform several tasks including tracking travel expenses, checking airline reservation status, and monitoring a calendar of appointments during the sales person's business trip. The functionality for each of these tasks individually may be provided by widgets and Enterprise widgets. In this embodiment, the sales person downloads a control widget (e.g. a widget briefcase) called “Salesperson_Travel_Tools” onto a laptop computer. The Enterprise employee launches the “Salesperson_Travel_Tools” widget briefcase, which automatically opens three widgets for the sales person within a widget runtime environment (e.g. any commercially available widget execution environment or widget container). A widget runtime environment provides a platform on which control widgets can execute, and may provide, for example, various interfacing and display functionality. In particular, the widget briefcase of this example launches (1) a travel expenses Enterprise widget that allows entry of travel expenses such as meal, taxi, and hotel receipts into an Enterprise backend database, (2) an airline status business widget used to check the status of the sales person's airline reservation and conduct a web-checkin if desired, both via the corresponding airline's Internet website, and (3) a travel calendar Enterprise widget for viewing the sales person's private calendar appointments stored in an Enterprise backend calendar server.

Each of the widgets and Enterprise widgets in the “Salesperson_Travel_Tools” widget briefcase could be downloaded, launched, tracked, and maintained separately, however use of the widget briefcase simplifies this process for the Enterprise employee. The widget briefcase persistently maintains the association between the three widgets on behalf of the Enterprise employee whether the associated widgets, referred to as “managed widgets,” are operating or not. In one embodiment, the sales person selects a hide function via the widget briefcase, and all three managed widgets are removed from the display screen, however an icon representing the launched widget briefcase having hidden managed widgets remains on the display screen indicating that the three managed widgets are in an intermediate state.

The sales person next arrives at a sales appointment, and launches a second widget briefcase named “Sales_Meeting_Tools.” This briefcase launches three additional managed widgets, in particular (1) an inventory status Enterprise widget to check the quantity of various products in inventory by pulling real-time data from an Enterprise backend server, (2) a cost basis business widget to lookup pricing information for specific products offered for sale by the sales person, the pricing information accessed from password protected vendor websites via the Internet, and (3) a quote emailer Enterprise widget that allows the sales person to enter a quoted product and price and automatically email a quote to the contact person via the Enterprise's secure email server.

After the sales meeting, the sales person unhides the “Salesperson_Travel_Tools” which has been executing in a background, but hidden from view. The sales person sees that his airline flight has been canceled from updated content data provided to the airline status business widget while it was hidden. The salesman downloads a new business widget used to make new airline reservations, and thinking it would be handy to have this widget associated with the “Salesperson_Travel_Tools” widget briefcase, the salesperson drags the new business widget onto the “Salesperson_Travel_Tools” widget briefcase, adding it to the widget briefcase (e.g. causing the new business widget to become persistently associated with the widget briefcase, and opened and closed automatically with the widget briefcase as with the other widgets already associated with the briefcase).

Through the use of preconfigured and customizable widget briefcases, Enterprise employees and other widget users may benefit by saving the time and effort previously required to search for, download, launch, maintain, and track their desired widgets.

As used herein, a widget refers to an application characterized by its limited and specific functionality relative to traditional feature rich applications. Widgets are further characterized by their visually small size in relation to a graphical user interface (“GUI”) desktop environment or the visual representation of a typical application executing on such a desktop environment. While a typical feature rich application in active use, such as a web-browser or a word-processor, normally consumes the majority of a full sized display, such as a 17″ graphical display monitor, a typical widget consumes less than 20% of the same two-dimensional space of the full sized display.

Widgets may also be referred to as “business widgets,” “Enterprise widgets,” “gadgets,” or “Portable Logic Modules (‘PLMs’).” Those having ordinary skill in the art will appreciate that a widget is not a traditional full feature application. For example, the World Wide Consortium (“W3C”) defines widgets as:
[U]sually small client-side applications for displaying and updating remote data, packaged in a way to allow a single download and installation on a client machine. The widget may execute outside the typical web browser interface. Examples include clocks, stock tickers, news casters, games and weather forecasters. Some existing industry solutions go by the names ‘widgets,’ ‘gadgets’ or ‘modules.’
   See World Wide Consortium, Widgets 1.0 (W3C Working Draft 9, November 2006). This W3C definition appropriately defines the class of applications referred to herein as widgets, business widgets, and Enterprise widgets, with the distinction that Enterprise widgets as described herein are enabled to communicate with backend servers protected by a secured network within an Enterprise backend environment.

Lastly, in the computer arts, the term “widget” is sometimes used to refer to the graphical components of a GUI, such as sliders, buttons, checkboxes, and dropdowns. This definition is not an appropriate characterization of widgets as used herein.

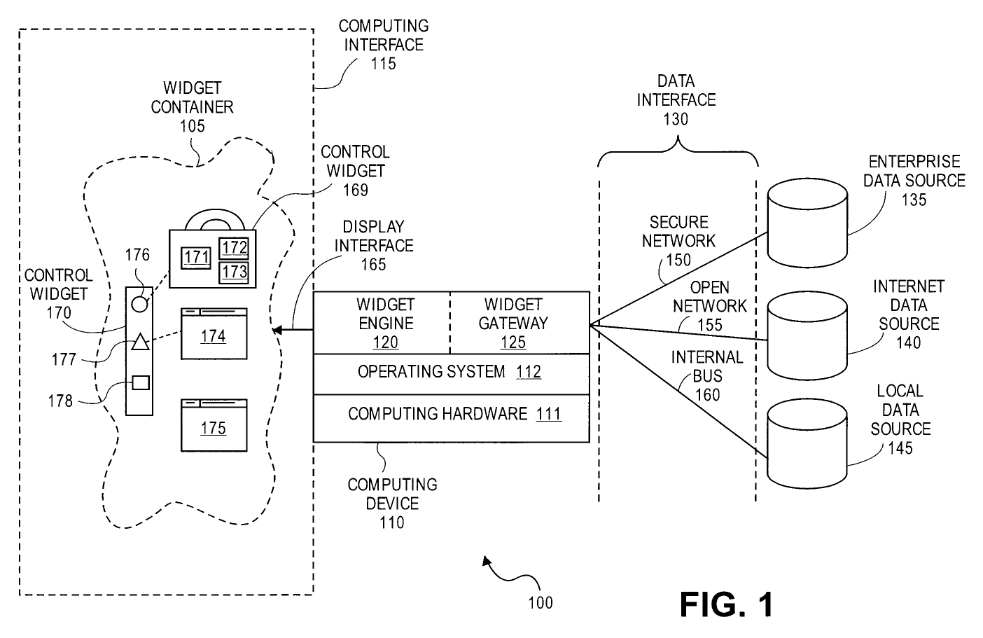

Refer now to FIG. 1 illustrating a system for persistently associating a control widget with a plurality of managed widgets within a widget container according to one embodiment.

Computing device 110 contains computing hardware 111 (e.g. a processor, memory, storage device, and other computer hardware components) and operating system 112. Widget engine 120 is an application running on operating system 112. Widget gateway 125 is a second application connected with widget engine 120, and further connected with data interface 130. Through data interface 130, widget engine 120 and widget gateway 125 can communicate with data sources 135, 140, and 145. In particular, widget gateway 125 can communicate with Enterprise data source 135 via secure network 150, Internet data source 140 via open network 155, and local data source 145 via internal bus 160.

Widget engine 120 is further connected with computing interface 115 which can display output and receive input on behalf of computing device 110 or its components. Computing interface 115 contains widget container 105 (e.g. a widget runtime environment). Widget container 105 is connected with computing device 110 and its components via display interface 165.

Widget container 105 and computing interface 115 displays control widget 169, a widget briefcase, and control widget 170, a widget launcher. Control widget 169 further includes managed widgets 171, 172, and 173. Control widget 170 includes widget icons 176, 177, and 178. Widget container 105 lastly includes managed widget 174 and unmanaged widget 175. Managed widget 174 is associated with widget icon 177 and unmanaged widget 175 is operating in widget container 105, but not associated with either control widget 169-170 or any other widget or widget icon.

Widget container 105 and computing interface 115 represents an input and output interface where a user may view widgets operating within widget container 105 via widget engine 120 and where users may further provide input to widgets or computing device 110 in general. Computing interface 115 may be any electronic device capable of receiving input and representing output. Common examples include pointing input devices (e.g. a mouse or stylus), key input devices (e.g. a keyboard or keypad), touch screen input devices, optical input devices, etc. Examples of computing interfaces 115 capable of conveying a representation of output include Video Graphics Array (“VGA”) monitors, Liquid Crystal Display (“LCD”) monitors, televisions, Personal Digital Assistant (“PDA”) display screens, audio speakers, computer printers, etc. The term “representation” refers to any manner in which information or data may be conveyed by electronic means. Common examples of such representations include textual representations, graphical representations, and audible representations.

In one embodiment, computing device 110 is a personal computer (“PC”) connected with computing interface 115. Computing interface 115 includes a “mouse” that captures a user's motions, a keyboard input device, and a computer display monitor. In an alternative environment, computing device 110 is a personal digital assistant (“PDA”) connected with computing interface 115. Computing interface 115 includes a stylus, a touch sensitive screen that captures input, and a graphical display integrated with the touch sensitive screen.

Examples of widget containers 105 (e.g. commercially available widget runtime environments) include Yahoo! Widget Engine™, Apple Macintosh Dashboard™, and Microsoft Windows Vista Gadgets™. Trademarks are the property of their respective owners and are used herein solely for the purposes of identification. Widgets may be created through the use of application development environments, widget development environments, and distributed-application development environments known in the art.

Computing interface 115 can receive input on behalf of control widgets 169-170 and other widgets 171-175, managed or unmanaged, operating within widget container 105. Input refers to any data, information, signal, indicator, variable, or value provided to widget container 105 or its elements via computing interface 115. Examples of input include text, sound, images, selections (e.g. clicking on a check box or radio button), and telemetry data from electronic sensors (e.g. vibration, temperature, elevation, and acceleration data). In one embodiment, computing interface 115 receives input from a user requesting widget briefcase 169 change the state of its associated managed widgets 171-173. In another embodiment, computing interface 115 sends input to control widget 170, the input requesting control widget 170 launch associated managed widget 174.

Widget engine 120 can receive input from widgets operating within widget container 105 via computing interface 115. Widget engine 120 can send requests to data sources 135, 140, and 145 via data interface 130. A request may include requesting information from data source 135-145, or writing information to data sources 135-145 via managed or unmanaged widgets 171-175. Data sources 135-145 may further send information to widget container 105 or any of widgets 169-178 operating within it. Data sources 135-145 may send information to widgets 171-175 in response to a prior request, or may send information to widgets 171-175 via an active or connected data interface 130, notifying individual or groups of widgets 171-175 that information pertaining to the function of the widgets has been changed or updated.

Widget gateway 125 enables widgets operating in widget container 105 to access data sources 135-145 without knowing the location, identity, or access mechanisms of data sources 135-145. Widget gateway 125 may be used to interface with diverse types of data interfaces, thus offloading or supplementing the standard functionality of widget engine 120, however, the functionality of widget gateway 125 can also be combined with widget engine 120. For example, in one embodiment, widget gateway 125 interfaces with Enterprise data source 135 protected by secure network 150. In this embodiment, widget gateway 125, sometimes referred to as an Enterprise widget interface or an Enterprise widget foundation, negotiates a communication path with the Enterprise data source over secure network 150. Widget gateway 125 may employ encryption and decryption methods, special keys, a challenge and response algorithm, firewalls, or a single sign on (“SSO”) service to negotiate the communication path with Enterprise level data source 135 operating on secure network 150.

In another embodiment, widget gateway 125 establishes a communication path with Internet data source 140 via unprotected open network 155. In yet another embodiment, widget gateway 125 establishes a connection with local data source 145, such as a hard drive, CD-ROM, DVD, or a removable RAM storage, via internal bus 160 available through computing hardware 111 of computing device 110. The communication paths established via data interface 130 may be of any type including wireless, wired, Ethernet, fiber optic, etc.

The various data sources 135-145 available via data interface 130 can be machines, computer, systems, or applications that process, store, and retrieve data for an application on the “front-end.” These data sources 135-145, sometimes called backend systems or backend servers do not interact directly with end-users, but rather interact via machine to machine (“M2M”) communications with front-end clients such as widgets 169-178 operating in widget container 105, or the widget container itself. As used herein, a front-end application is one with which a user can directly interface, while a backend system is not directly interfaced by the user. Rather, backend systems are accessed on behalf of the user via interfaces available to front-end applications.

Widgets 169-178 operating within widget container 105 may store functions, data, attributes, and variables in data objects. A data object is an individual unit of run-time data storage that may be used as a basic functional element. A data object may be capable of receiving messages, processing data, and sending messages to other data objects. The data objects are objects compatible with object oriented programming (“OOP”) languages or object databases. Many programming languages support data objects, including: Java, JavaScript, C#, .Net (pronounced “dot-net”), C++, Python, Perl, PHP, etc.

Enterprise data source 135 may be any system that contains data necessary to fulfill solicited operations requested by widget container 105 or its widgets. In one embodiment, Enterprise data source 135 is a Lightweight Directory Access Protocol (“LDAP”) compatible system. In another embodiment, Enterprise data source 135 is a network file server. In yet another embodiment Enterprise data source 135 is a Sun Microsystems Network File System (“NFS”) compatible data repository hosted by a Unix server.

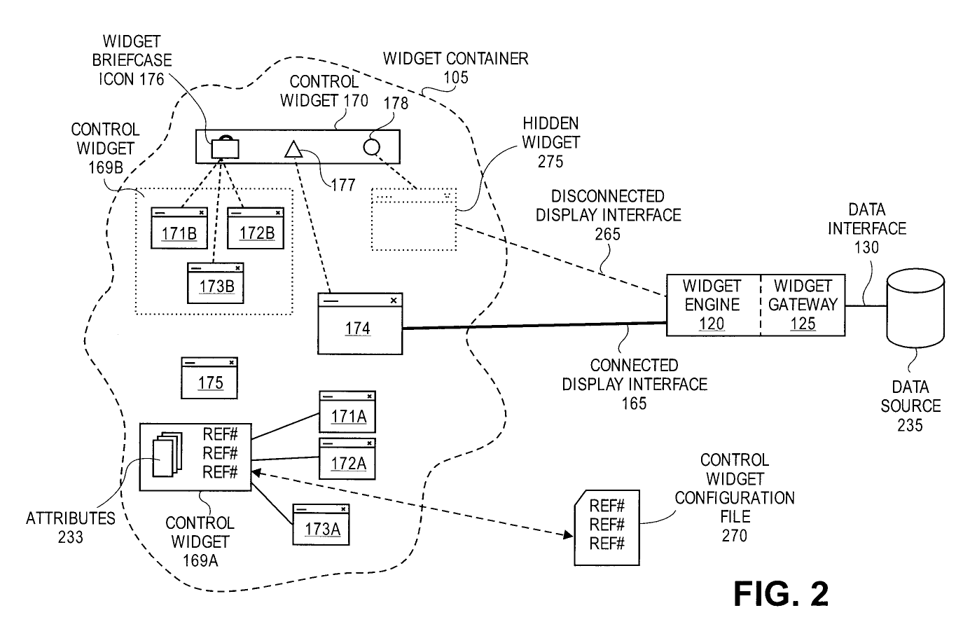

Refer now to FIG. 2 illustrating the interactions and interrelationships of control widgets 169-170, managed widgets 171-174, and unmanaged widgets (e.g. unmanaged widget 175) within widget container 105 according to a particular embodiment.

Widget engine 120 manages widget container 105, which represents an example of a runtime environment for control widgets. Widget engine 120 is connected with widget gateway 125. Widget gateway 125 is connected with data source 235 via data interface 130, thus allowing widgets 169-178 operating within widget container 105 to send and receive information from data source 235.

Widget container 105 illustrates several managed and unmanaged widgets 171-175 and control widgets 169-170. Control widget 170 has three widget icons 176, 177, and 178. Widget icon 176 is depicted as a widget briefcase icon. Widget icon 176 is associated with control widget 169B and when upon request (e.g. upon receiving user input from widget container 105), widget icon 176 launches control widget 169B, which includes sub-widgets 171B, 172B, and 173B. Widget icon 177 is associated with, and can launch managed widget 174. Widget icon 178 is associated with and can launch widget 275, depicted in FIG. 2 as a hidden widget. Widget 275 is depicted as hidden because its display interface 265 has been disconnected, and thus it not displayed (the dotted line is for purposes of illustration), and cannot be viewed until disconnected display interface 265 is reconnected. Managed widget 174 is not hidden and is connected with widget engine 120 via connected display interface 165. Managed widget 174 is additionally connected with data source 235 via active data interface 130 and widget gateway/engine 120-125.

Control widget 169A depicts three reference numbers (e.g. “REF#”) correlating to managed widgets 171A, 172A, and 173A. The association of managed widgets 171A, 172A, and 173A with control widget 169A is stored in control widget configuration file 270 in a computer readable storage medium, such as computing hardware 111. Lastly, unmanaged widget 175 is shown operating within widget container 105, but has no association with control widgets 169 or 170.

A control widget, such as widget briefcases 169A and 169B may be used to associate or group together any number of widgets, Enterprise widgets, control widgets, or business widgets. Control widgets 169-170 that contain one or more widgets may be identified as a file or object within an operating system 112 environment, for example, by control widget configuration file 270 having an extension of “.briefcase” or “.launcher” pronounced “dot briefcase” or “dot launcher” respectively, and having a period as a separator between the file name and the file type. A control widget 169-170, can operate as a widget in of itself, capable of interacting with commercially available widget runtime environments (e.g. widget container 105). However, control widgets 169-170, unlike traditional widgets, persist or maintain information associating them with other control widgets. Control widgets 169-170 manage and are capable of affecting the state of other control widgets (such as opening, closing, hiding, and unhiding as described above).

Widget briefcases 169A and 169B may be provided to an end user as strategically arranged groups of widgets that are considered pertinent to a specific Enterprise employee type or job duty. Other briefcases may be generated for any other logical grouping of widgets. As one example, in one embodiment widget briefcase 169B is provided to an Enterprise sales employee. The widget briefcase 169B contains references to managed widgets 171B, 172B, and 173B, each of which support the job responsibilities of the Enterprise sales employee. For example, in this embodiment, managed widget 171B monitors a queue of sales opportunities, managed widget 172B retrieves specific sales orders based on a salesperson's identity, a customer ID, a part number, or a sales order number, and lastly, managed widget 173B displays real-time sales statistics customizable by time, salesperson, part number, or sales group.

Control widgets 169-170 persist association information describing a relationship between the control widget (e.g. 169 or 170) with one or more managed widgets (e.g. 171A-173A or 171B-173B). For example, control widget 169A is associated with managed widgets 171A, 172A, and 173A. Control widget 169A persists this association (e.g. stores, maintains, keeps, tracks, or records the association describing the relationship) by storing a reference (e.g. a pointer, file reference, memory location reference or pointer, network location reference, etc.) corresponding with each managed widget, 171A, 172A, and 173A, in control widget configuration file 270. The control widget configuration file can be maintained in a computer memory (e.g. operating random access memory of computing hardware 111) or stored in a hard disk drive of computing hardware 111, or in both locations. Control widget configuration file 270 may be any type of file (e.g. XML), data object, metadata or other data mechanism accessible to control widget 169A. The reference maintained by control widget 169-170, is used to uniquely refer to any given widget operating within or accessible from widget container 105.

In one embodiment an end-user modifies a local copy of control widget 169 provided as a strategically arranged group of widgets. In another embodiment, control widget 169 is centrally maintained and shared among many end-users and therefore cannot be modified by a single end-user. A single end-user however may create a local copy of centrally maintained control widget 169, and modify the local copy. In yet another embodiment an end-user or common group of end-users can create a shared control widget 169 that is modifiable by end-users belonging to the common group. In this embodiment, all end-user in the group have write access to shared control widget 169, and modifications to shared control widget 169 are immediately reflected in all instances of the same control widget 169 being utilized by end-users of the common group. This type of shared control widget 169 may also be referred to as a decentrally maintained control widget 169.

Control widgets 169-170 may also be created and customized by an end user to associate any widget, Enterprise widget, business widget, or other control widget that an Enterprise employee or an end-user desires to associate in a common control widget (e.g. 169 or 170). In one embodiment, an Enterprise employee creates widget briefcase 169A, and then adds three managed widgets 171A, 172A, and 173A to widget briefcase 169A. Managed widget 171A is an Enterprise widget that monitors status of a system under test in an Enterprise factory, managed widget 172A monitors the Enterprise employee's vacation calendar kept on a backend Enterprise human-resources database, and managed widget 173A captures and submits daily status reports to an Enterprise manager for the Enterprise employee.

Control widgets 169-170 can be marked as read-only without copy, for example if the Enterprise deems the widgets in widget briefcase 169B to be sensitive. For example, in one embodiment, the human-resources department creates widget briefcase 169B and names it “Enterprise employee human-resources briefcase,” and then configures the briefcase to be read-only without copy. The human-resource department then adds three sensitive Human Resources related Enterprise widgets to widget briefcase 169B as managed widgets 171B, 172B, and 173B. The human-resources department distributes widget briefcase 169B with its managed widgets to all employees in the Enterprise. Enterprise employees who attempt to copy, modify, or delete widget briefcase 169B receive an error message. The human resources department however, can later add unmanaged widget 175 to widget briefcase 169B as a fourth managed widget, and previously unmanaged widget 175 is then reflected in widget briefcase 169B for all Enterprise employees as managed widget 175.

Control widgets 169-170 may have additional attributes that affect their behavior and representation. For example, Control widgets 169-170 can be labeled or named, configured to dock or float, configured to stack vertically or line up horizontally, configured to automatically update themselves or to automatically update each of the managed widgets they are associated with, configured to appear as a widget icon within widget container 105, an icon within a parent widget launcher 170 or an icon within a parent widget briefcase 169B, and so on.

Attributes 233 can store information for control widgets 169-170 and other managed or unmanaged widgets 171-175. Attributes 233 may be any data, variable, parameter, or other information related to the operation or configuration of control widgets 169-170. For example, attributes 233 can affect the representation of data in control widgets 169-170 or their associated managed widgets, the graphical display of control widgets 169-170 themselves or the managed widgets they reference, the operation of control widgets 169-170 or the widgets they manage, characteristics of control widgets 169-170, etc. Examples of attributes 233 within control widgets 169-170 and managed widgets can include widget size, widget position (e.g. on the desktop), widget representation type (e.g. graphical, textual, audible), widget state, widget docking mode, widget interrelationships, widget name, default services, default behavior when errors occur, etc.

A control widget 169-170, may contain (e.g. point to or reference) other control widgets 169-170 as managed control widgets or sub control widgets, as well as contain other managed widgets. For instance, widget launcher 170 contains a reference to widget briefcase 169B, represented by widget briefcase icon 176. Widget briefcase 169B, whose parent is widget launcher 170, contains sub-references to managed widgets 171B, 172B, and 173B. Widgets 171B, 172B, and 173B could in turn be control widgets, for example a widget briefcase or widget launcher, or other widgets, Enterprise widgets, and business widgets. In one embodiment, Control widget 170, a widget launcher, contains three widget briefcases, 176-178, each represented by widget icons. In this embodiment, control widget 170 maintains associations with widget briefcases 176-178 categorized into themes based upon the managed widgets they contain. In particular, widget briefcase 176 contains “sales tasks” managed widgets, widget briefcase 177 contains “personal tasks” managed widgets, and briefcase 178 contains “human-resources” related Enterprise widgets. In an alternative embodiment, Control widget 169A, a widget briefcase, contains three widget briefcases, 171A, 172A, and 173A. Alternatively, control widget 169 or 170 may contain a mix of managed widgets and managed control widgets (e.g. widget launchers, widget briefcases, or both).

A control widget that holds other control widgets may be referred to as an Enterprise widget family, but is more simply control widget 169-170 with sub managed control widgets 169-170. An Enterprise widget family, or widget family can be used to associate multiple managed control widgets and managed widgets in the same manner as control widgets 169-170 are used to associate multiple managed widgets.

Control widgets 169-170 can be sent to other end-users or Enterprise employees via any electronic transfer method, such as email, ftp, http download, storage and retrieval from a removable storage medium, posted on a website, etc. For example, a widget transfer tool available via widget engine 120 can be used to email widget briefcase 169A to another person. In one embodiment, control widget 169A holds only references to managed widgets 171A, 172A, and 173A, and so a widget transfer tool copies managed widgets 171A, 172A, and 173A, packages the copied widgets together with the widget references from control widget configuration file 270, and emails the package to a selected recipient.

Control widgets 169-170 are drag and drop compatible with a variety of widgets including other control widgets. Drag and drop compatibility allows control widgets 169-170 or managed and unmanaged widgets 171-175 to be dragged onto another object creating an association or relationship, and also to accept other objects dragged and dropped onto them. When control widgets 169-170, and other widgets are dragged and dropped to, or dragged and dropped on, a default event is triggered causing a further action. The default event can be user configurable and stored in attributes 233 depending on the type of object involved in the drag and drop event.

Dragging and dropping can be described as the action of selecting an object on a graphical interface (e.g. a widget, control widget, file, icon, etc.), causing the selected object to move on the graphical interface, positioning the selected object at least partially over a second object (e.g. a drag and drop target), and releasing or deselecting the selected object while it is at least partially overlapping (graphically) a target object. Releasing or deselecting the selected object can be any means of indicating to the graphical interface that the final resting position of the selected object is at least partially overlapping or shared in two-dimensional space with the target object. Thus, when the system indicates an object is dragged and dropped (e.g. its final resting position on the desktop display at least partially overlaps with the widget), one or more actions can occur.

In a particular embodiment, unmanaged widget 175 is dragged and dropped onto managed widget 174. The default drag and drop event is configured to add both the dragged and dropped unmanaged widget 175 and the target managed widget 174 into a new control widget, either widget launcher 170 or widget briefcase 169 depending on the configuration. In another embodiment, unmanaged widget 175 is dragged and dropped onto existing briefcase 169B, and is added to briefcase 169B.

Managed widgets in control widgets 169-170 can be represented differently depending on configuration. In one embodiment, widgets associated with widget launcher 170 are displayed as widget icons 176, 177, and 178 within a displayed representation of the widget launcher. Widgets in a graphical representation of a widget briefcase (e.g. element 169 of FIG. 1), or they can be represented individually within widget container 105 without a graphical representation of their parent control widget. For example, FIG. 2 depicts an invisible widget briefcase 169B associating managed widgets 171B, 172B, and 173B, which can reside anywhere within widget container 105.

Through the use of control widgets 169-170 as described herein, widgets can have various states. For example, widgets can be closed or open in the traditional sense. A closed widget (e.g. not executing) may have a configuration information stored in a file system within computing hardware 111, but does not consume memory or processor time, is not displayed via widget container 105, and cannot communicate with data source 235. An open widget on the other hand has memory allocated to its operation, normally through widget container 105, consumes processor bandwidth, is displayed via widget container 105 (e.g. is viewable on a display), and can communicate with data source 235 via data interface 130.

Control widgets 169-170 allow for an additional operational state of managed widgets 171-173. In particular, via control widgets 169-170, widgets may be hidden, but continue to operate. For example, widget 275 is depicted as a hidden widget and is not displayed via widget container 105 as display interface 265 between widget 275 and widget engine 120 has been disconnected. Hidden widget 275 does, however, maintain an active connection with data source 235 via data interface 130. Data source 235 can send updated information to hidden widget 275. Control widget 170 maintains an association with hidden widget 275 and may display widget icon 178 within a representation of control widget 169 or 170. An associated control widget 169 or 170 can launch, hide, and unhide hidden widget 275. In one embodiment, clicking on widget icon 178 will unhide widget 275 associated with control widget 170 when managed widget 275 is hidden. Alternatively, if managed widget 275 is closed or not executing, clicking on widget icon 178 will launch managed widget 275. If managed widget 275 is executing and viewable, then clicking on widget icon 178 will hide managed widget 275, but not close it, allowing managed widget 275 to continue receiving update data from data source 235 via data interface 130.

The state of managed widgets 171-174 can be changed in different ways, depending on the type of widget container 105 or managed widgets 171-174 associated with a control widget (e.g. 169 or 170). In one embodiment, control widget 169A changes the state of managed widgets 171A, 172A, and 173A as a group by sending a request to a widget runtime environment (e.g. widget container 105) requesting the widget runtime environment to open, close, or hide the managed widgets 171A, 172A, and 173A. In this embodiment, three distinct requests are sent from control widget 169A to the widget runtime environment requesting the changed state, with one request corresponding with each managed widget. Control widget 169A processes and sends the three requests as a group, but the widget runtime environment need not be aware of the association between control widget 169A with managed widgets 171A, 172A, and 173A. The widget runtime environment processes the three requests and because the three requests were sent as a group, the requests appear to be processed as a group to an observing user.

In an alternative embodiment, control widget 169A changes the state of managed widgets 171A, 172A, and 173A as a group by sending a request to widget engine 120, which in turn processes the request to change the state of managed widgets 171A, 172A, and 173A. In yet another embodiment, control widget 169A changes the state of managed widgets 171A, 172A, and 173A as a group by sending a request to operating system 112. In a particular embodiment, the state of an individual managed widget (e.g. 171B) is changed by control widget 169B separately from the other managed widgets (e.g. 172B and 173B), and the changed state of the individual managed widget is persisted when the other managed widgets are opened, closed, or hidden as a group.

When managed widget 275 is unhidden, any updated data or information received while hidden will be displayed if the updated information affects the displayed representation managed widget 275 (e.g. an updated stock price may be displayed while a change in operational code might not affect the displayed representation). Updated information that can be received while a widget is hidden includes updated operating logic from data source 235 (e.g. updated code, business logic, or a patch for the widget), updated operational parameters from the data source (e.g. updated thresholds for alarms, such as a change in maximum allowable temperature for a temperature sensor), updated display content from the data source (e.g. modified or new postings on an electronic message board, an instant messenger window, or an updated weather report), and updated database fields from the data source (e.g. a new meeting appointment added to a calendar, or a transaction posted to a checking account). Data source 235 may “push” updated information to all widgets connected with the data source via data connection 130. For example, data source 235 may push a required patch to all connected widgets of a certain type, or may push an alarm message to all connected widgets programmed to monitor and display the alarm message.

Some updated information, such as a patch to update the version of the widget may have no effect on the displayed representation of the widget once viewable or unhidden, while other updated information, such as an updated weather forecast will be received by the widget while hidden, and the updated information will be reflected in the displayed representation of a managed widget once unhidden. To be clear, once unhidden, a managed widget need not query data source 235 to check for and request updated information, rather the updated information is received and acted upon while hidden (e.g. apply a patch or update display content), and then once unhidden, a widget's displayed representation will reflect any changes received that affect the widget's external appearance.

Clicking on a representation of a briefcase, such as widget briefcase icon 176 or a viewable electronic briefcase container (e.g. element 169 of FIG. 1) can trigger one event to be effected for all the widgets or control widgets associated with the briefcase representation. In one embodiment, widget briefcase icon 176 is associated with control widget 169B (a briefcase), and control widget 169B is associated with managed widgets 171B, 172B, and 173B. In this embodiment, clicking on widget briefcase icon 176 when some or all of widgets 171B, 172B, and 173B are open and viewable (e.g. not hidden), causes all widgets associated with control widget 169B, to become hidden. Clicking on widget briefcase icon 176 again causes all widgets associated with control widget 169B to become viewable (e.g. displayed or unhidden). Clicking on widget briefcase icon 176 when one or more widgets associated with control widget 169B are closed (e.g. not executing), causes the one or more closed widgets to launch, and all widgets associated with control widget 169B to be displayed via widget container 105.

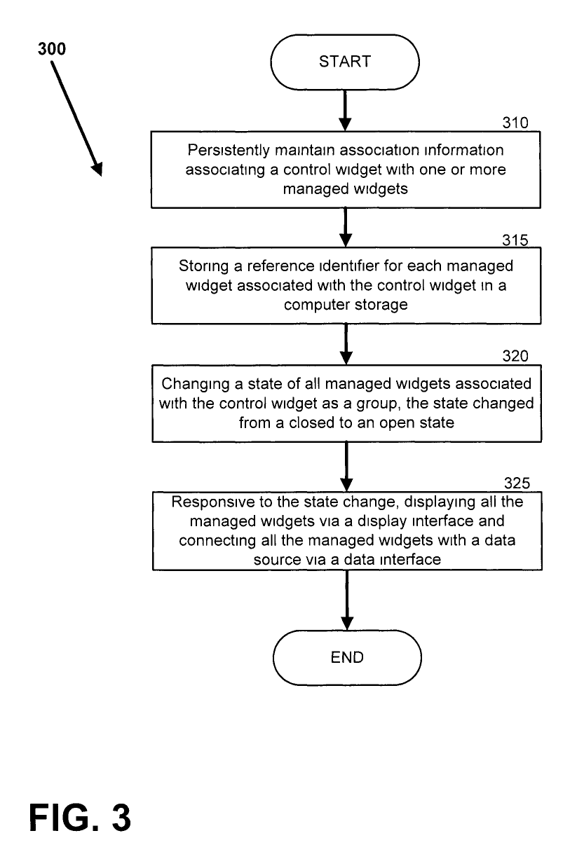

FIG. 3 illustrates a flowchart depicting various functional blocks, some optional, of a method for persistently associating managed widgets 171-174 with a control widget (e.g. 169 or 170) in accordance with an embodiment.

More particularly, at block 310 a control widget persistently maintains association information associating the control widget with one or more managed widgets. At block 315, the control widget stores a reference identifier for each of the managed widgets associated with the control widget in a computer storage (e.g. storing control widget configuration file 270 in a hard disk drive or computer memory of computing hardware 111). At block 320, control widget changes a state (e.g. open, closed, or an intermediate hidden state) of all the managed widgets associated with the control widget from closed to open (e.g. a control widget such as widget launcher 170 or widget briefcase 169 launches/opens all the managed widgets associated with it).

At block 325, in response to the change in state from closed to open, the control widget connects each of the associated managed widgets with a display interface to display each of the managed widgets, and further connects each of the managed widgets with a data source (e.g. Enterprise data source 135, Internet data source 140, and/or local data source 145) via data interface 130.

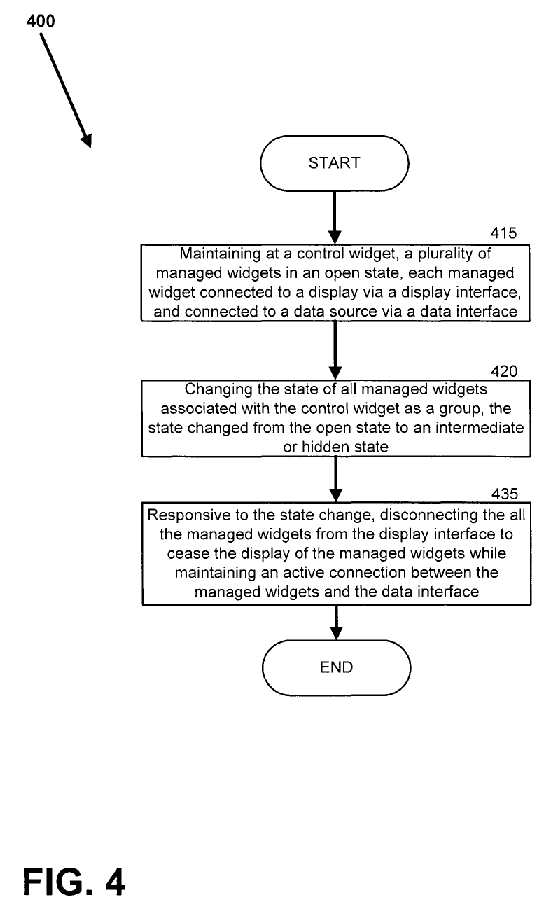

FIG. 4 illustrates a flowchart depicting various functional blocks, some optional, of a method for changing the state of managed widgets persistently associated with a control widget from open to hidden.

At block 415, a control widget (e.g. 169 or 170) maintains managed widgets (e.g. 171-174) in an open state. Each managed widget has a connection with a display via display interface 165 and a connection with data source 235 via data interface 130. At block 420, the control widget changes the state of all the managed widgets from their open state to a hidden state (e.g. an intermediate state where each managed widget is not closed, and not open). At block 435, in response to the change in state of the managed widgets from open to hidden, the control widget disconnects each managed widget from the display interface, thus stopping each managed widget from being displayed. The control widget however, maintains an active connection between the managed widgets and data interface 130 while the managed widgets are in a hidden state, thus allowing the managed widgets to receive update information from any data source connected with data interface 130.

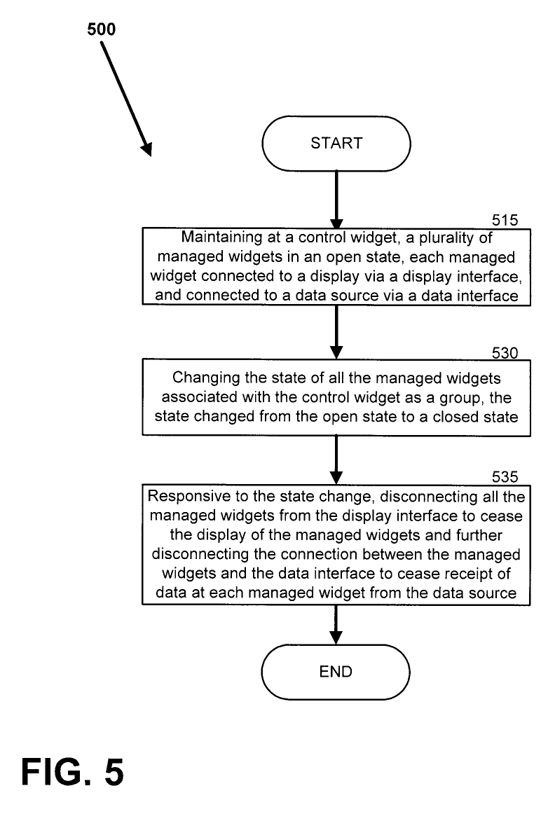

FIG. 5 illustrates a flowchart depicting various functional blocks, some optional, of a method for changing the state of managed widgets persistently associated with a control widget from open to closed in accordance with another embodiment.

At block 515, a control widget (e.g. 169 or 170) maintains several managed widgets in an open state. Each managed widget has a connection with a display via display interface 165 and a connection with one or more data sources via data interface 130. At block 530, the control widget changes the state of all the managed widgets from their open state to a closed state as a group. At block 535, in response to the change in state of the managed widgets from open to closed, the control widget disconnects each managed widget from the display interface, thus stopping each managed widget from being displayed, and further disconnects each managed widget from data interface 130, thus stopping data communications between the managed widgets and any previously connected data source.

Parts or elements of the present invention may be implemented in hardware, firmware, software, or in combination. For example, in one embodiment, attributes 233 are maintained in hardware via registers on a printed circuit board (“PCB”). In an alternative embodiment, attributes 233 are maintained entirely by software as virtual locations in a computer memory. In yet another embodiment, a combination of firmware, hardware and software are used to maintain attributes 233 stored on a hard disk drive, and the physical storage is controlled by the hard disk drive's firmware and the values of attribute 233 are controlled by software. Furthermore, components of the present invention may be combined or segmented into additional parts and maintain harmony within the spirit of the invention. For example, widget engine 120 of computing device 110 may be combined with widget gateway 125 in accordance with the present invention. In an alternative embodiment, computing hardware 111 may be broken down into a computer memory, a computer hard disk drive, a computer logic circuit, all connected with computing interface 115 via internal bus 160.

Parts or elements of the invention may also be stored as instructions on a machine readable medium, computer readable medium, or storage medium (e.g. hard disk drives, floppy disks, compact disks (CD-ROM disks), digital versatile disks (DVDs), solid state flash drives, computer memory (RAM), network file servers, internet protocol (IP) packets read via a wired or wireless network connection, etc. In one embodiment, computing device 110 has a hard disk drive with software (e.g. computer instructions) stored on it. Computing hardware 111 of computing device 110 includes a central processing unit (“CPU”) to execute instructions including the software stored on the hard disk drive and software associated with operating system 112. In this embodiment, the CPU loads the instructions from the hard disk drive into random access memory (RAM) and executes them. When executed, the processor performs operations including persisting association information to associate a control widget with one or more managed widgets operating within a widget runtime environment; storing the association information on a computer readable storage medium (e.g. a memory or a hard disk drive); changing an operating state of the managed widgets associated with the control widget as a group (e.g. changing from open to closed, or closed to open, or open to hidden/intermediate); and representing the state changes of the managed widgets via a display.

Thus, system 100 and methods 300, 400, and 500 for persistently associating managed widgets 171-174 with control widgets 169-170 has been disclosed. Enabling control widgets 169-170 to group and associate other control widgets, business widgets, and Enterprise widgets as managed widgets 171-173 and perform actions on those managed widgets as a group may result in improved utility for Enterprise employees and other users who employ widgets to perform job duties including accessing Enterprise data. Users of control widgets 169-170 as disclosed herein may further benefit from improved collaboration with other control widget users through sharing of widget briefcases 169 and widget launchers 170. It should be understood that although the details of the various embodiments disclosed herein are with respect to one or two control widgets 169-170 or three or four managed widgets 171-174, more than one or two control widgets may be used, and more or fewer managed widgets may be used contemporaneously and are considered part of the present invention.

1. A method in a control widget, comprising:
persisting association information describing a relationship between the control widget and a plurality of managed widgets;
changing a state of one or more of the plurality of managed widgets, wherein changing the state includes opening, closing, and setting the one or more managed widgets to an intermediate state distinct from being either open or closed; and
representing the state of each of the plurality of managed widgets on a display.

2. The method of claim 1, wherein the control widget is a widget briefcase, and wherein changing the state of the one or more of the plurality of managed widgets comprises:
changing the state of all of the plurality of managed widgets as a group.

3. The method of claim 1, wherein the control widget is a widget launcher, and wherein changing the state of the one or more of the plurality of managed widgets comprises:
changing the state of one selected managed widget based on an input received at the control widget.

4. The method of claim 1, wherein persisting the association information describing the relationship between the control widget and the plurality of managed widgets comprises:
persisting the association information to associate at least one Enterprise widget with the control widget, the Enterprise widget to access Enterprise data stored at a backend Enterprise server.

5. The method of claim 1, wherein persisting the association information describing a relationship between the control widget and the plurality of managed widgets comprises:
persisting the association information to associate at least one managed widget having association information to associate the at least one managed widget with one or more sub-managed widgets, wherein the at least one managed widget is a second control widget.

6. The method of claim 1, wherein persisting the association information comprises:
storing a reference identifier for each managed widget in a memory location or a file or both.

7. The method of claim 1, wherein changing the state of the managed widgets further comprises:
sending a request to a widget container to execute the change of state, wherein the widget container provides a runtime environment for the control widget.

8. The method of claim 1, wherein changing the state of the one or more of the plurality of managed widgets comprises:
launching each of the one or more managed widgets, wherein launching each managed widget includes:
connecting each managed widget with a data source via a data interface, and
connecting each managed widget with a display interface, the display interface to display each managed widget.

9. The method of claim 8, wherein connecting each managed widget to the data source comprises:
connecting each managed widget with one or more of an Enterprise data source accessible via a secure network, an Internet server accessible via an open network, or a local storage device accessible via a local bus.

10. The method of claim 1, wherein setting the one or more managed widgets to the intermediate state comprises:
hiding each of the one or more managed widgets.

11. The method of claim 10, wherein hiding each managed widget comprises:
disconnecting each managed widget from the display interface, ceasing display of the managed widget; and
maintaining a connection between each managed widget and a data source via a data interface.

12. The method of claim 1, wherein setting the one or more managed widgets to the intermediate state distinct from being either open or closed comprises:
maintaining a connection between each managed widget and a data source via a data interface; and
receiving while in the intermediate state, update data from the data source, including one or more of operating logic, operational parameters, display content, and database fields.

13. The method of claim 1, further comprising:
unhiding each of the one or more managed widgets in response to a request at the control widget, wherein unhiding each managed widget includes:
reconnecting the managed widget with a display interface, the display interface to redisplay the managed widget and any update data received by the managed widget.

14. The method of claim 1, wherein closing the one or more of the plurality of managed widgets comprises:
disconnecting each of the one or more managed widgets from a connected data interface and associated data source, ceasing the receipt of update data from the data source; and
disconnecting each of the one or more managed widgets from a display interface, ceasing the display of the managed widget.

15. The method of claim 1, further comprising:
receiving an indication of a final resting position on the display of an unassociated widget;
determining the final resting position of the unassociated widget at least partially overlaps with a graphical representation of the control widget; and
associating the unassociated widget with the control widget as one of the plurality of managed widgets.

16. The method of claim 1, further comprising:
changing the state of an individual managed widget separately from the remaining managed widgets; and
persisting the change of state of the individual managed widget to retain the changed state of the individual widget when the other widgets are opened, closed, or hidden as a group.

17. A computing device comprising a machine-readable medium having instructions stored thereon that, when executed by a processor, cause the processor to perform operations including:
persisting association information describing a relationship between a control widget and a plurality of managed widgets;
changing a state of one or more of the plurality of managed widgets, wherein changing the state includes opening, closing, and setting the one or more managed widgets to an intermediate state distinct from being either open or closed; and
representing the state of each of the plurality of managed widgets on a display connected with the computing device.

18. The computing device of claim 17, wherein persisting the association information describing a relationship between the control widget and the plurality of managed widgets comprises:
persisting the association information to associate at least one managed widget having association information to associate the at least one managed widget with one or more sub-managed widgets, wherein the at least one managed widget is a second control widget.

19. The computing device of claim 17, wherein changing the state of the one or more of the plurality of managed widgets comprises:
launching each of the one or more managed widgets, wherein launching each managed widget includes:
connecting each managed widget with a data source via a data interface, and
connecting each managed widget with a display interface, the display interface to display each managed widget.

20. The computing device of claim 17, wherein setting the one or more managed widgets to the intermediate state comprises:
hiding each of the one or more managed widgets, wherein hiding each managed widget comprises:
disconnecting each managed widget from the display interface, ceasing display of the managed widget; and
maintaining the connection of each managed widget with the data source via the data interface.

21. A system comprising:
means for persisting association information describing a relationship between a control widget and a plurality of managed widgets;
means for changing a state of one or more of the plurality of managed widgets, wherein changing the state includes means for opening, closing, and setting the one or more managed widgets to an intermediate state distinct from being either open or closed; and
means for representing the state of each of the plurality of managed widgets on a display.

22. The system of claim 21, wherein persisting the association information describing a relationship between the control widget and the plurality of managed widgets comprises:
means for persisting the association information to associate at least one managed widget having association information to associate the at least one managed widget with one or more sub-managed widgets, wherein the at least one managed widget is a second control widget.

23. The system of claim 21, wherein changing the state of the one or more of the plurality of managed widgets comprises:
means for launching each of the one or more managed widgets, wherein launching each managed widget includes:
means for connecting each managed widget with a data source via a data interface, and means for connecting each managed widget with a display interface, the display interface to display each managed widget.

24. The system of claim 21, wherein setting the one or more managed widgets to the intermediate state comprises:
means for hiding each of the one or more managed widgets, wherein hiding each managed widget comprises:
means for disconnecting each managed widget from the display interface, ceasing display of the managed widget; and
means for maintaining the connection of each managed widget with the data source via the data interface.

25. The system of claim 21, further comprising:
means for changing the state of an individual managed widget separately from the remaining managed widgets; and
means for persisting the change of state of the individual managed widget to retain the changed state of the individual widget when the other widgets are opened, closed, or hidden as a group.
